(19) United States
(12) Patent Application Publication
(10) Pub. No.: US 2017/0277225 A1
(43) Pub. Date: Sep. 28, 2017

(54) ELECTRONIC DEVICE

(71) Applicant: Lenovo (Beijing) Limited, Beijing (CN)

(72) Inventor: Jihun Yeom, Beijing (CN)

(21) Appl. No.: 15/470,540

(22) Filed: Mar. 27, 2017

(30) Foreign Application Priority Data
Mar. 28, 2016 (CN) 201610183731.3

(51) Int. Cl. G06F 1/16; G09G 5/00

(52) U.S. Cl. CPC G06F 1/1652; G06F 1/1647; G09G 5/003; G09G 2380/02

(57) ABSTRACT

One embodiment provides an electronic device, comprising: a flexible device body; and at least one display screen arranged on the device body; a processor; a memory device that stores instructions executable by the processor to: determine a display mode of the electronic device, wherein the display mode comprises a first display mode and a second display mode; and display, based on the determining, contents on the at least one display screen; wherein the electronic device in the first display mode is in an unfolded state and wherein the electronic device in the second display mode is in a folded state. Other aspects are described and claimed.

### CLAIM FOR PRIORITY

This application claims priority to Chinese Application No. 201610183731.3, filed on Mar. 28, 2016, which is fully incorporated by reference herein.

### FIELD

The subject matter described herein relates to the field of electronic technologies, and in particular, to an electronic device.

### BACKGROUND

With the development of electronic technologies, more and more portable electronic devices are integrated into people's lives, for example, smart phones, tablets, wearable-type devices and the like. Further, with the development of display technologies, flexible screens are also gradually being applied to these electronic devices.

### BRIEF SUMMARY

In summary, one aspect provides an electronic device, comprising: a flexible device body; and at least one display screen arranged on the device body; a processor; a memory device that stores instructions executable by the processor to: determine a display mode of the electronic device, wherein the display mode comprises a first display mode and a second display mode; and display, based on the determining, contents on the at least one display screen; wherein the electronic device in the first display mode is in an unfolded state and wherein the electronic device in the second display mode is in a folded state.

Another aspect provides a method, comprising: determining, using a processor, a display mode of the electronic device, wherein the display mode comprises a first display mode and a second display mode; and displaying, based on the determining, contents on the at least one display screen; wherein the electronic device in the first display mode is in an unfolded state and wherein the electronic device in the second display mode is in a folded state.

A further aspect provides a product, comprising: a flexible device body; at least one display screen arranged on the device body; a storage device that stores code, the code being executable by the processor and comprising: code that determines a display mode of an electronic device, wherein the display mode comprises a first display mode and a second display mode; and code that displays, based on the determining, contents on the at least one display screen; wherein the electronic device in the first display mode is in an unfolded state and wherein the electronic device in the second display mode is in a folded state.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 is a structural schematic diagram showing the structure of an electronic device according to an embodiment.

FIG. 2 is a structural schematic diagram showing the electronic device according to an embodiment.

FIG. 3 is a structural schematic diagram showing another structure of the electronic device according to an embodiment.

FIG. 4 is a structural schematic diagram showing the electronic device according to an embodiment.

FIG. 5 is a structural schematic diagram showing the electronic device according to an embodiment.

FIG. 6 is a structural schematic diagram showing the structure of a first connecting member according to an embodiment.

FIG. 7 is a structural schematic diagram showing another structure of the first connecting member according to an embodiment.

FIG. 8 is a structural schematic diagram showing yet another structure of the first connecting member according to an embodiment.

FIG. 9 is a structural schematic diagram showing the structure of a second connecting member according to an embodiment.

FIG. 10 is a structural schematic diagram showing another structure of the second connecting member according to an embodiment.

FIG. 11 is a structural schematic diagram showing yet another structure of the second connecting member according to an embodiment.

FIG. 12 is a structural schematic diagram showing the structure of a filling block according to an embodiment.

FIG. 13 is a structural schematic diagram showing the assembly of a first connecting member, a second connecting number, and a sliding shaft according to an embodiment.

FIG. 14 is a structural schematic exploded diagram of the structure in FIG. 13.

FIG. 15 is a structural schematic diagram showing the structure in FIG. 13 from another angle.

FIG. 16 is a structural schematic diagram showing the structure in FIG. 15 in a bent state.

FIG. 17 is a structural schematic diagram showing the structure in FIG. 15 at a maximum degree of bending.

FIG. 18 is a structural schematic diagram showing the structure of a third connecting member according to an embodiment.

FIG. 19 is a structural schematic diagram showing another structure of the third connecting member according to an embodiment.

FIG. 20 is a structural schematic diagram showing the structure of a fourth connecting member according to an embodiment.

FIG. 21 is a structural schematic diagram showing another structure of the fourth connecting member according to an embodiment.

FIG. 22 is a structural schematic diagram showing yet another structure of the fourth connecting member according to an embodiment.

FIG. 23 is a structural schematic diagram showing the assembly of the first connecting member, the second connecting number, the third connecting member, the fourth connecting member, the filling block, and the sliding shafts according to an embodiment.

FIG. 24 is an exploded view showing the assembly of the first connecting member, the second connecting number, the third connecting member, the fourth connecting member, the filling block, and the sliding shafts according to an embodiment.

FIG. 25 is a structural schematic diagram showing the structure of a flexible device according to an embodiment.

FIG. 26 is a structural schematic diagram showing the structure of the flexible device in FIG. 25 from another angle.

FIG. 27 is a structural schematic diagram showing the structure of the flexible device in FIG. 25 in a bent state.

FIG. 28 is a structural schematic diagram showing the structure of the flexible device in FIG. 25 in another bent state.

FIG. 29 is a structural schematic diagram showing the structure of a sheet-like filling block according to an embodiment.

FIG. 30 is a structural schematic diagram showing the structure of a sheet-like third connecting member according to an embodiment.

FIG. 31 is a structural schematic diagram showing the structure of a sheet-like fourth connecting member according to an embodiment.

FIG. 32 is a structural schematic diagram showing the structure of a flexible device in which each of the connecting members is a sheet-like structure according to an embodiment.

FIG. 33 is a structural schematic diagram showing the structure of a first connecting member manufactured by stamping, cutting and curling according to an embodiment.

FIG. 34 is a perspective view of the structure in FIG. 33.

FIG. 35 is a structural schematic diagram showing the structure of a second connecting member manufactured by stamping, cutting and curling according to an embodiment.

FIG. 36 is a perspective view showing the structure in FIG. 30.

FIG. 37 is a structural schematic diagram showing the structure of a flexible device having the connecting members in FIGS. 29 and 30 according to an embodiment.

FIG. 38 is an exploded view of the structure in FIG. 37.

FIG. 39 is a structural schematic diagram showing the structure of the flexible device in FIG. 37 in a bent state.

FIG. 40 is a structural schematic diagram showing the structure of a first member portion according to an embodiment.

FIG. 41 is a perspective view showing the structure of the first member portion in FIG. 40.

FIG. 42 is a structural schematic diagram showing the structure of a second member portion according to an embodiment.

FIG. 43 is a perspective view showing the structure of the second member portion in FIG. 42.

FIG. 44 is a structural schematic diagram showing the structure of a third member portion according to an embodiment.

FIG. 45 is a perspective view showing the structure of the third member portion in FIG. 44.

FIG. 46 is a structural schematic diagram showing the structure of a fourth member portion according to an embodiment.

FIG. 47 is a perspective view showing the structure of the fourth member portion in FIG. 46.

FIG. 48 is a structural schematic diagram showing the structure of a flexible device having the first member portion, the second member portion, the third member portion, and the fourth member portion according to an embodiment.

FIG. 49 is a structural schematic diagram showing the structure of the flexible device in FIG. 48 in a bent state.

FIG. 50 is a structural schematic diagram showing the structure of a first fixed connection piece according to an embodiment.

FIG. 51 is a structural schematic diagram showing the structure of a second fixed connection piece according to an embodiment.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Compared with a conventional display screen, the flexible display screen is not only lighter and thinner in volume, but also has lower power consumption, and further has the characteristics of being deformable. However, the flexible display screen, though having characteristics such as being deformable, displays content on a bent screen at a duller level than a common display screen does.

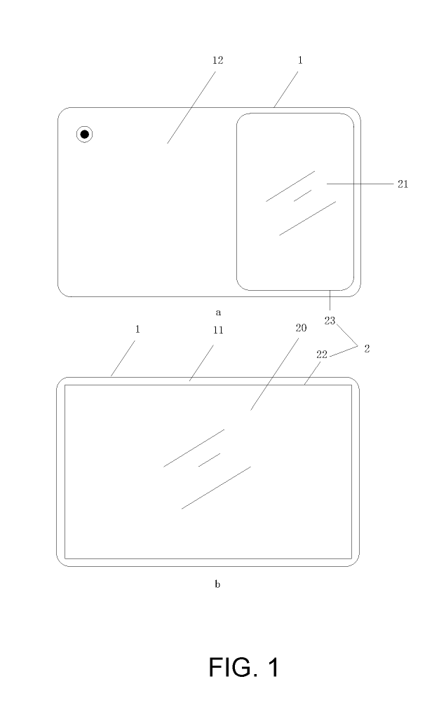

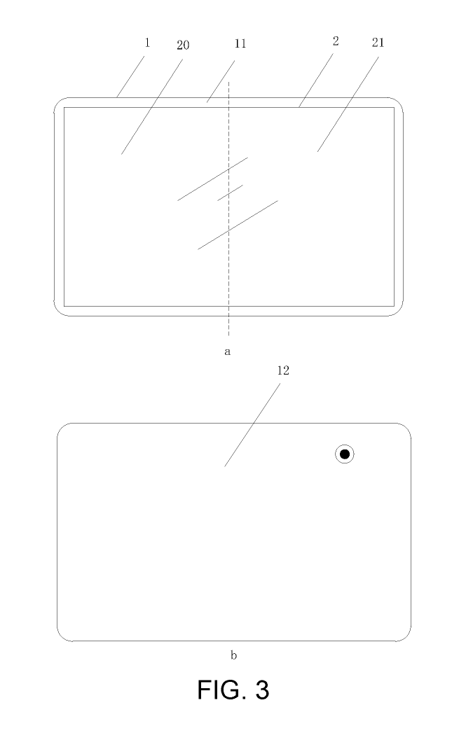

Referring now to FIG. 1 and/or FIG. 3, an embodiment provides an electronic device according to an embodiment. The electronic device includes a device body 1 and a display screen 2 arranged on the device body 1, and the display screen 2 includes a first display region 20 and a second display region 21. Specifically, the electronic device has a first display mode and a second display mode different from the first display mode. In the first display mode, the device body 1 is in an unfolded state, and the electronic device displays contents to be displayed on the first display region 20. In the second display mode, the device body 1 is in a folded state, and the electronic device displays the contents to be displayed on the second display region 21.

One possible implementation is as follows. Referring further to FIG. 1(a-b), the display screen 2 includes a first display screen 22 and a second display screen 23. The first display screen 22 is a flexible display screen and the second display screen 23 may be a flexible display screen or, alternatively, may be a non-flexible display screen. The first display screen 22 is arranged on a first side 11 of the device body 1, and the second display screen 23 is arranged on a second side 12 opposite to the first side 11. The first display region 20 is a display region of the first display screen 22, and the second display region 21 is a display region of the second display screen 23.

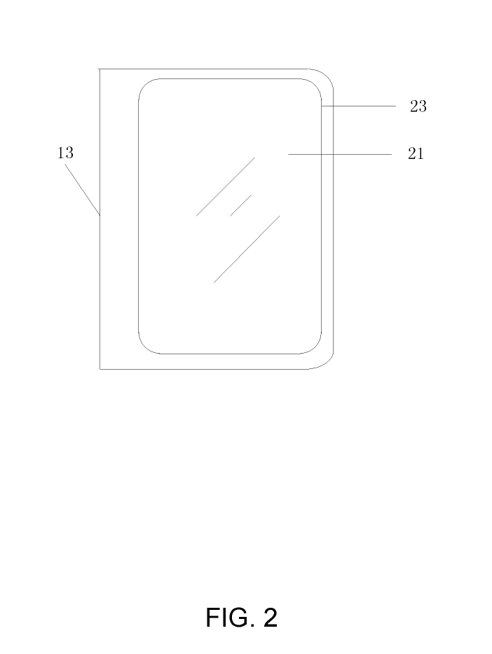

Referring to FIG. 2, the device body 1 is bent to form a first bending line 13. The device body 1 can be folded into a first folded state based on the first bending line 13, and the first display screen 22 deforms flexibly with the device body 1. In the case where the electronic device is in the first folded state, a first sub-display region and a second sub-display region of the first display screen 22 face each other.

In the first display mode, the device body 1 is in an unfolded state and the electronic device displays contents to be displayed on the first display screen 22. Reference is further made to FIG. 1, which is a schematic view showing the electronic device in the unfolded state. In the first display mode, the electronic device is in a tablet mode. In the second display mode, the device body 1 is in a folded state, and the electronic device displays the contents to be displayed on the second display screen 23. Reference is further made to FIG. 2, which is a schematic view showing the electronic device in a folded state. In the second display mode, the electronic device is in a cellphone mode.

Another possible implementation is as follows. The display screen 2 is a flexible display screen arranged on a first side 11 of the device body 1. As shown in FIG. 3, the flexible display screen deforms flexibly with the device body 1. No display screen is provided on a second side 12 opposite to the first side 11 of the device body 1, as shown in FIG. 3b. Specifically, the first display region 20 and the second display region 21 are two sub-display regions on the display screen 2.

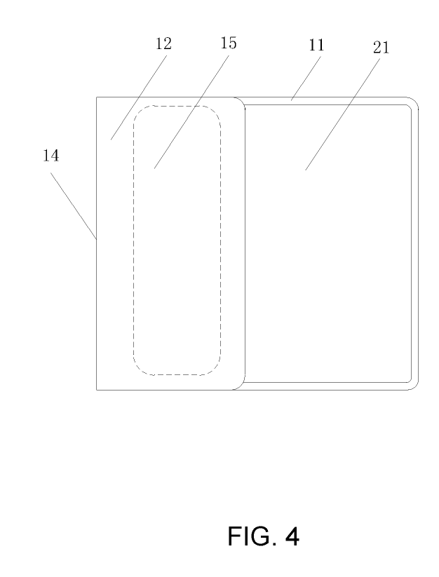

In an optional embodiment, referring to FIG. 4, the device body 1 provides a first bending line and a second bending line. The first bending line being formed by deforming the device body outwards (not illustrated) and the second bending line 14 being formed by deforming the device body inwards. An input device 15 is provided on the second side 12 opposite to the first side 11 of the device body 1. Due to the bending along the first bending line, an included angle between the input device 15 and the second display region 21 is less than 180 degrees. The second display region 21 and the input device 15 form a laptop, as shown in FIG. 4 which a schematic view is showing the electronic device folded into a laptop.

In the first display mode, the device body 1 is in an unfolded state and the electronic device displays the contents to be displayed by the first display region 20 and the second display region 21 together. In the first display mode, the electronic device is in a tablet mode. In the second display mode, the device body 1 is in a folded state. In the second display mode, the device body 1 provides a first bending line and a second bending line. The first bending line being formed by deforming the device body 1 outwards and the second bending line 14 being formed by deforming the device body 2 inwards and the electronic device being in a laptop mode.

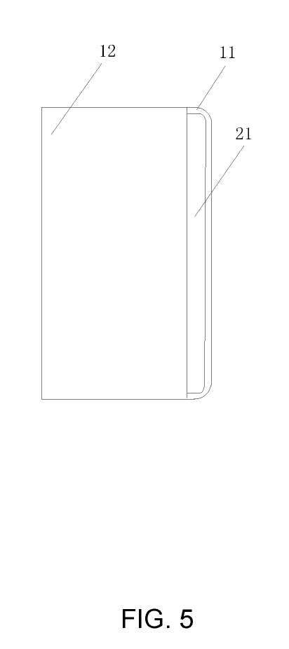

Referring to FIG. 5, in the case where the input device (not illustrated) and the second display region 21 face each other, the electronic device is folded into a cellphone mode.

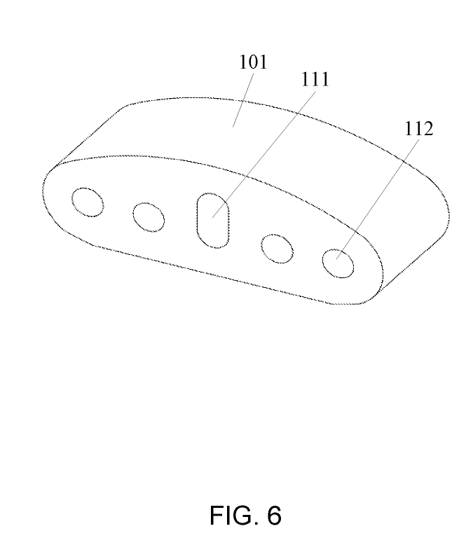

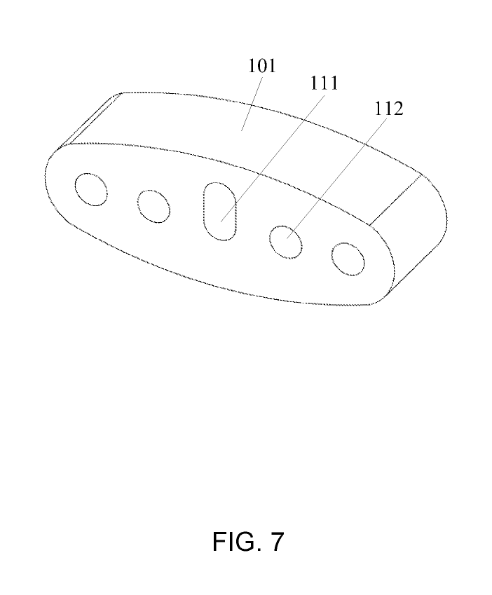

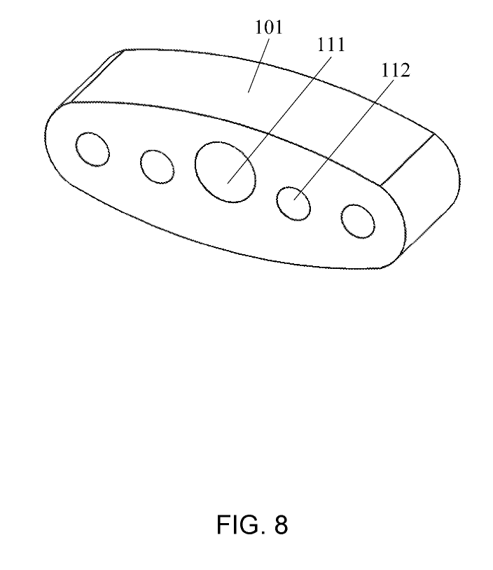

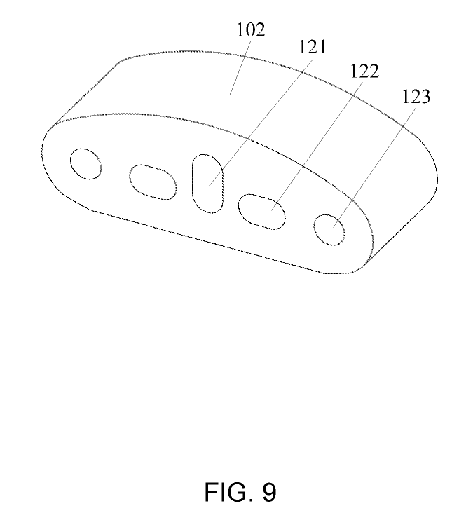

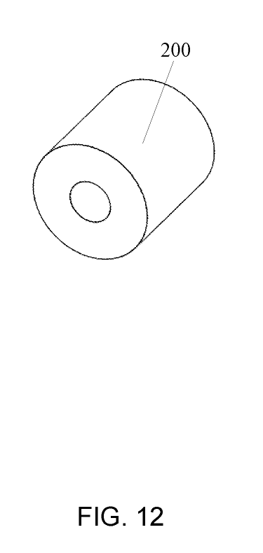

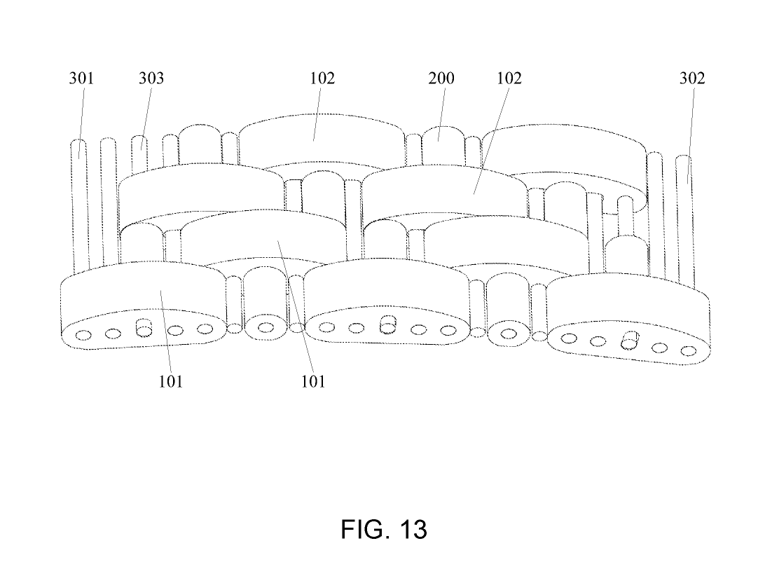

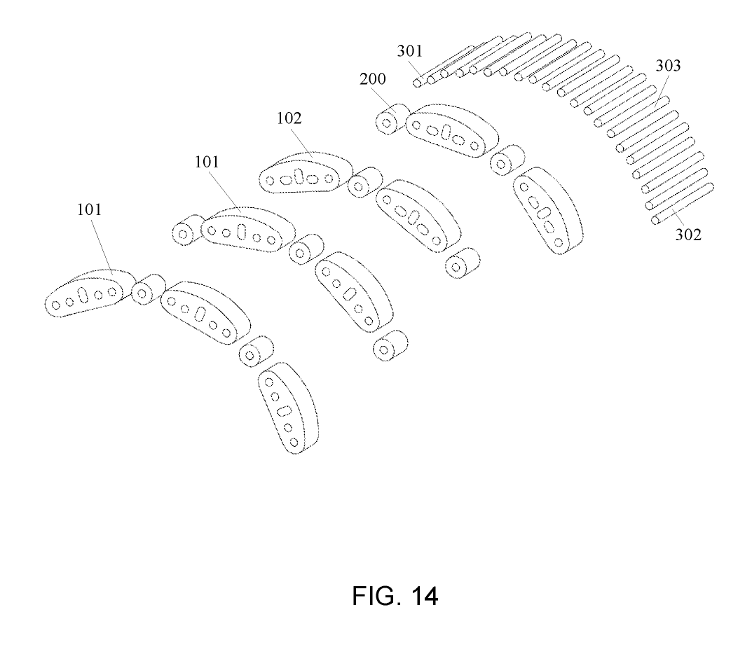

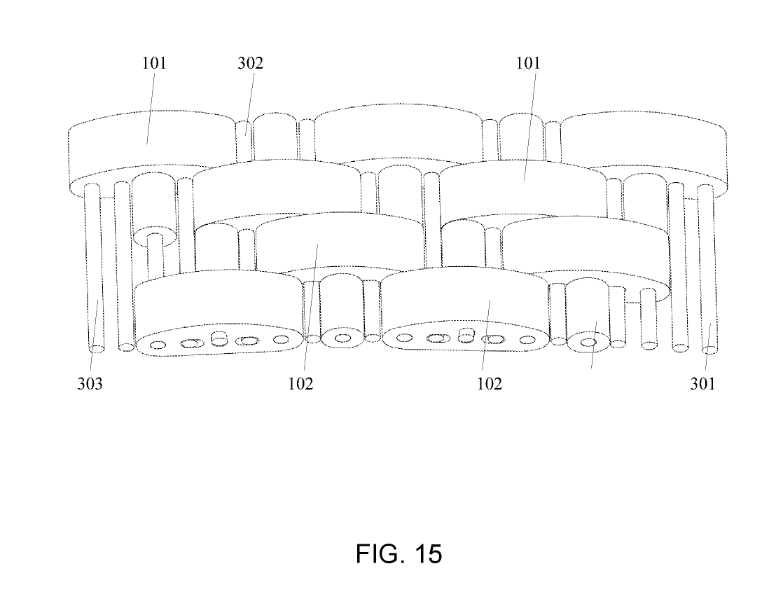

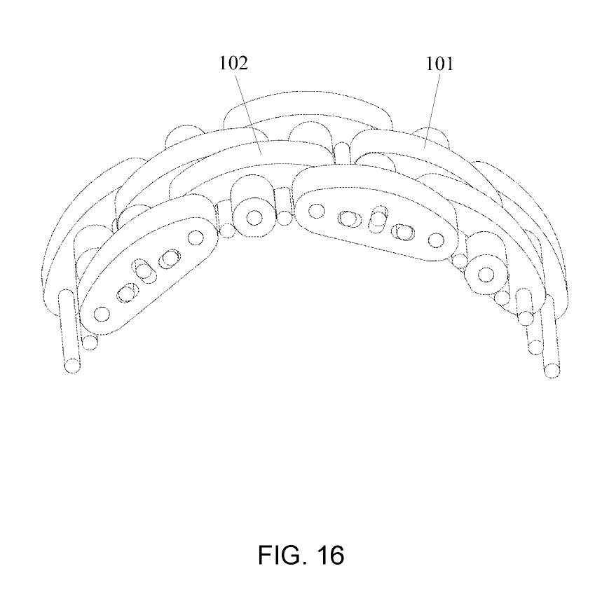

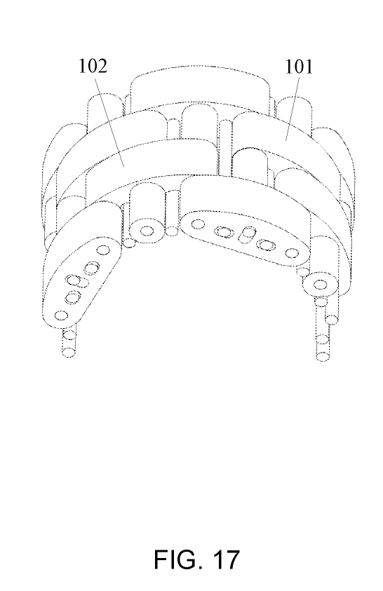

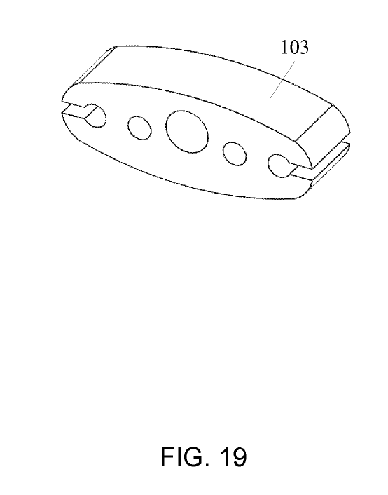

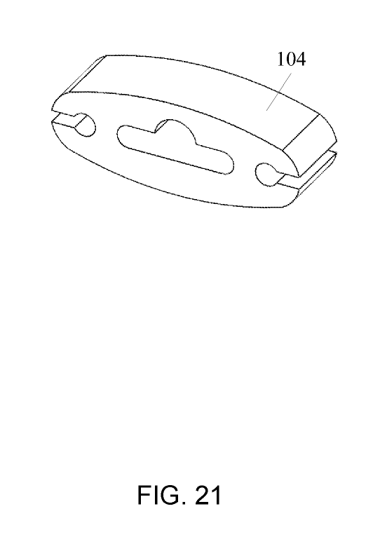

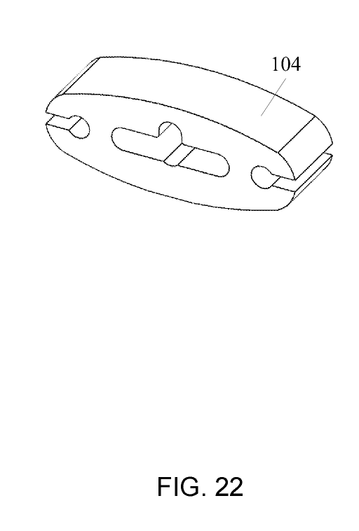

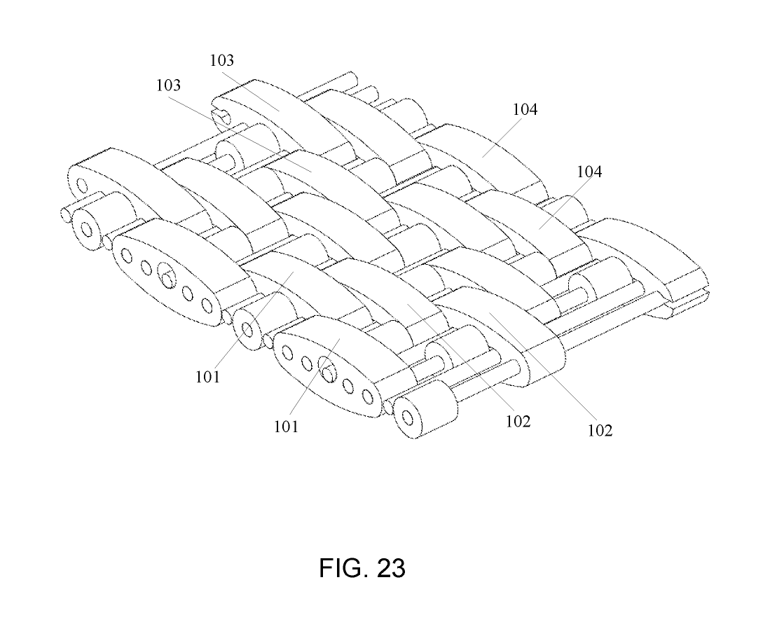

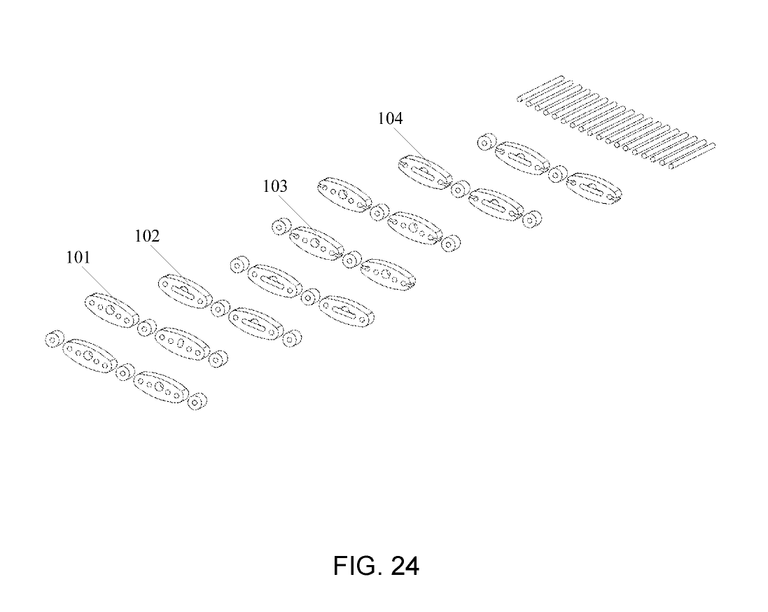

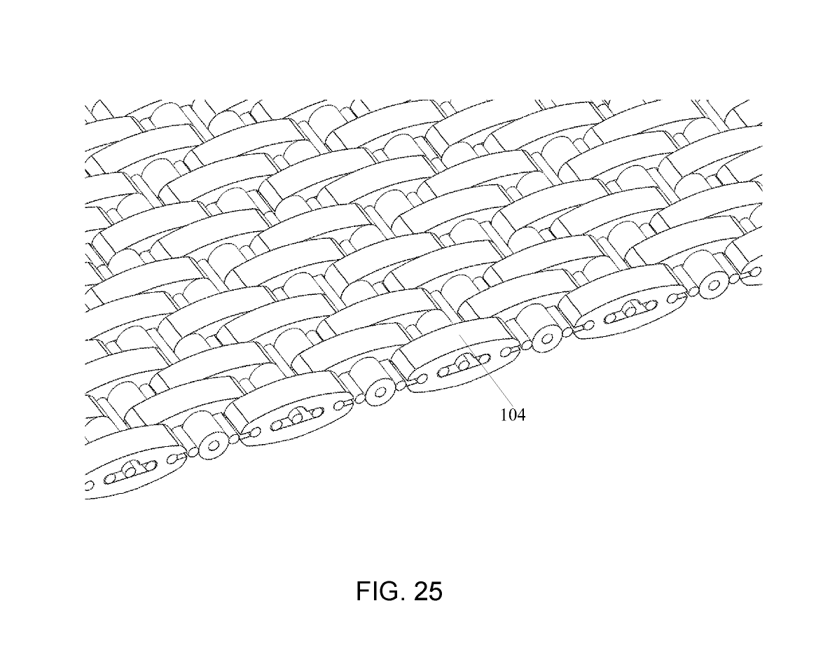

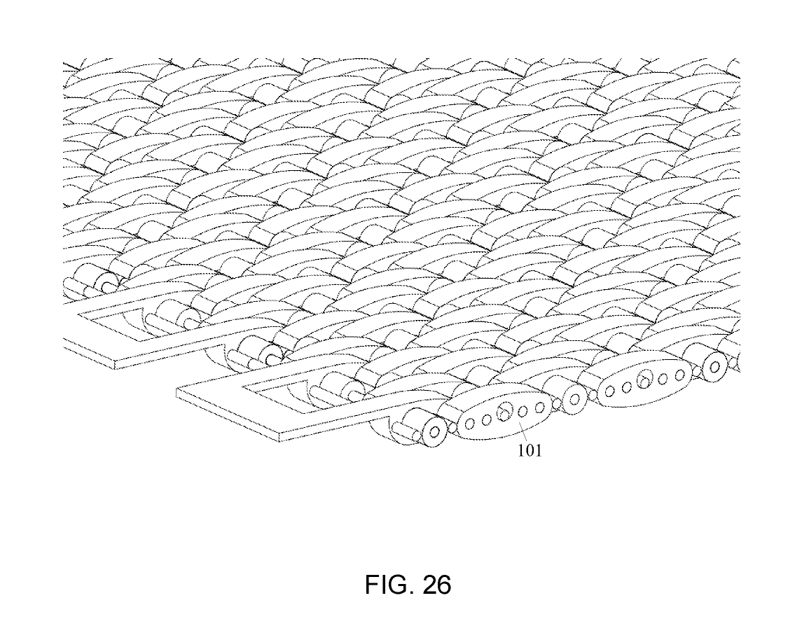

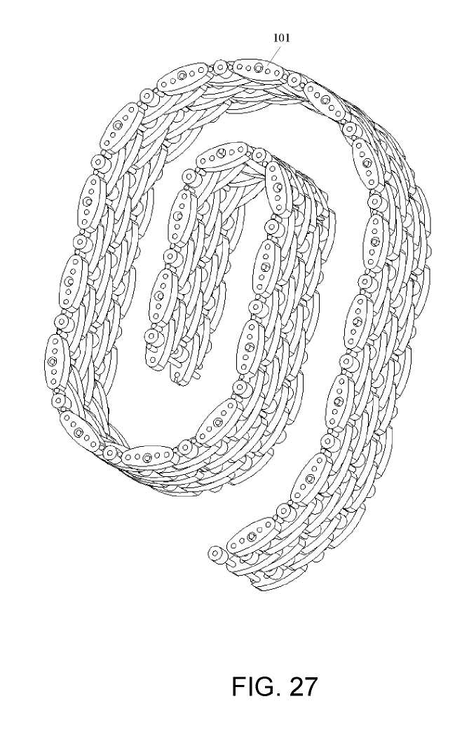

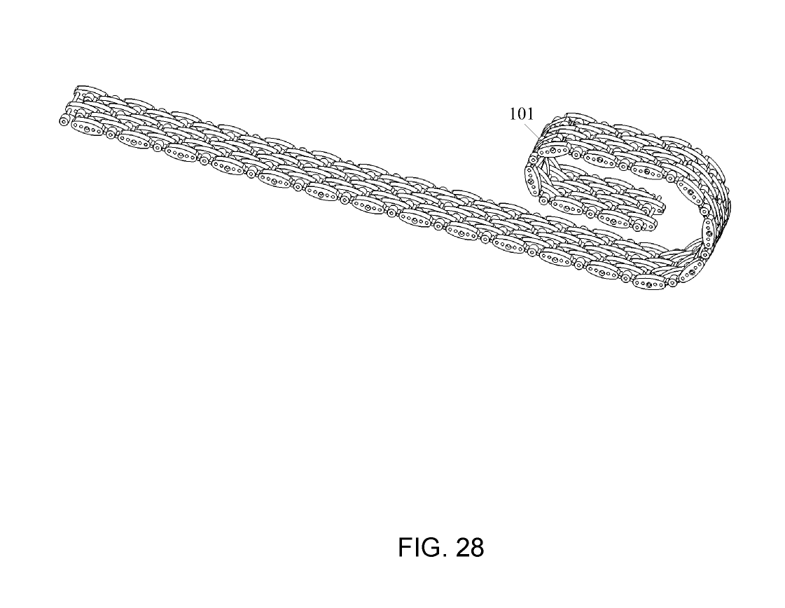

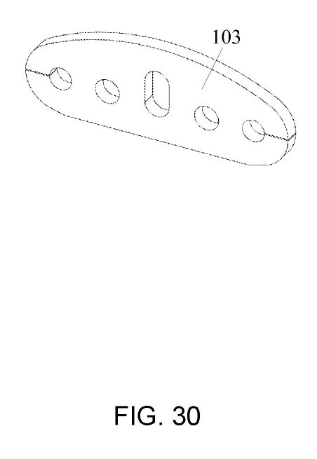

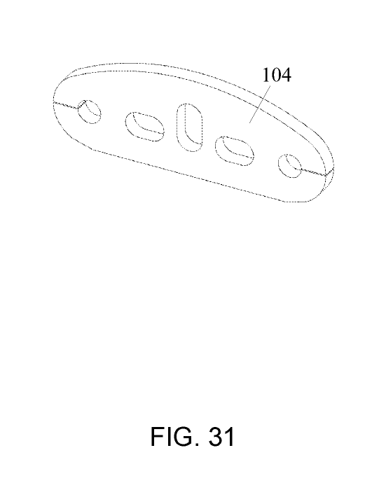

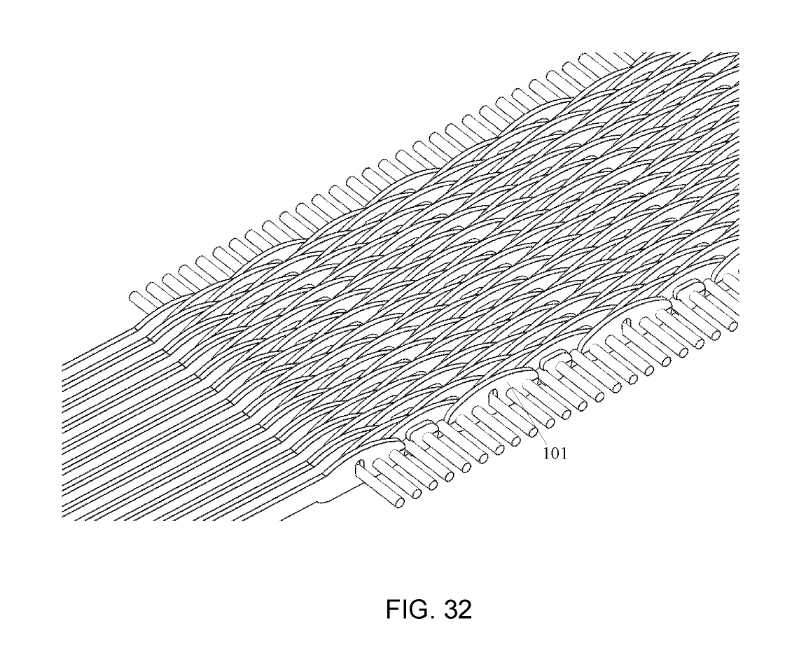

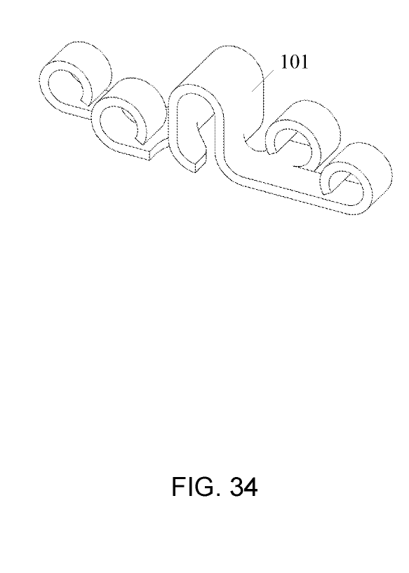

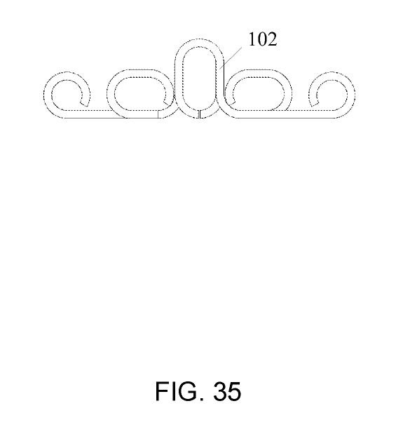

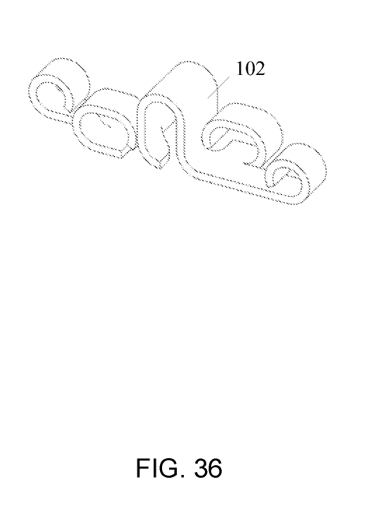

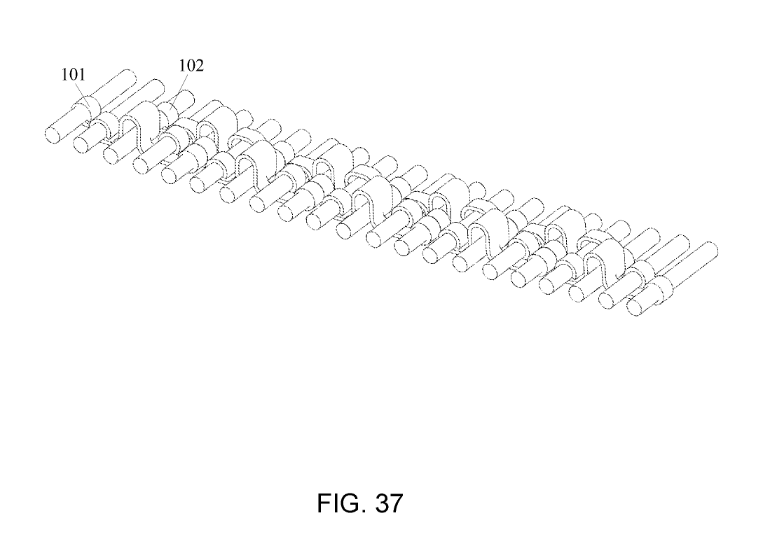

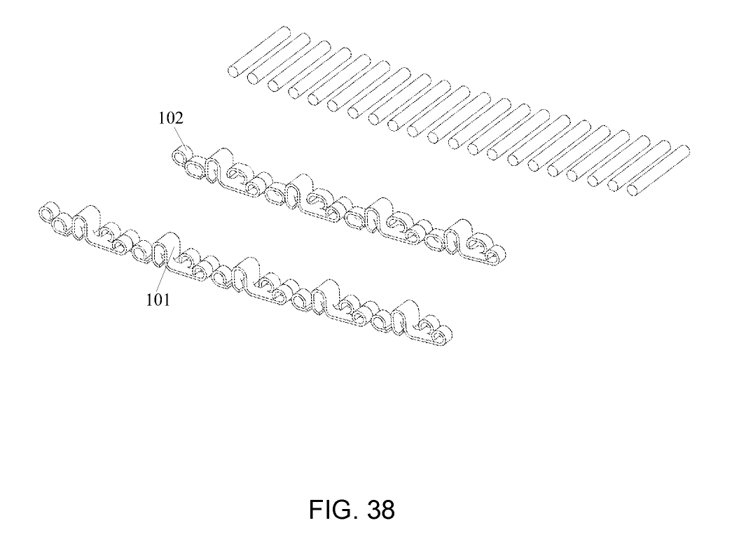

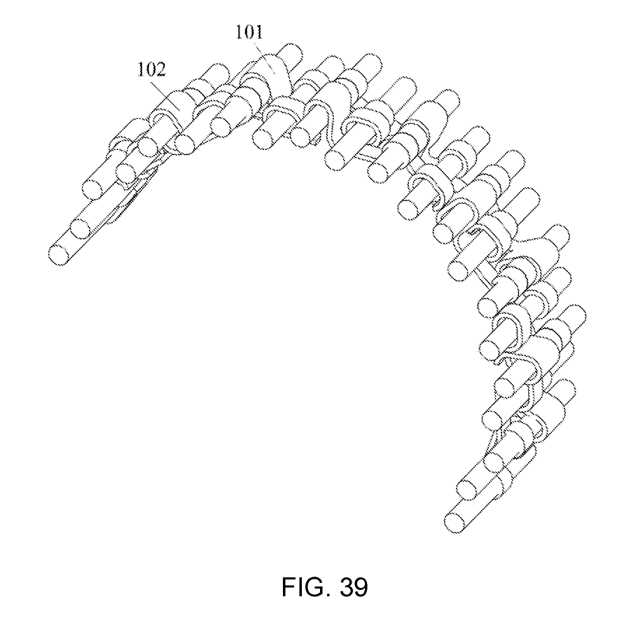

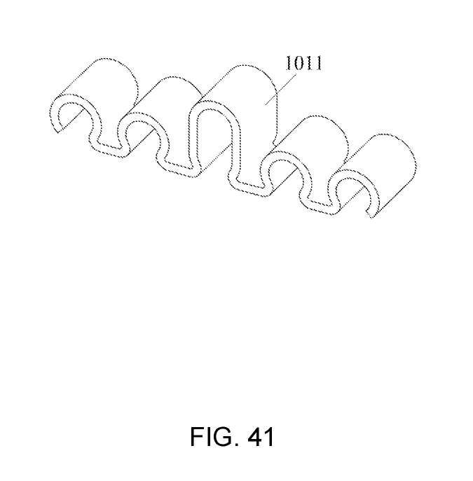

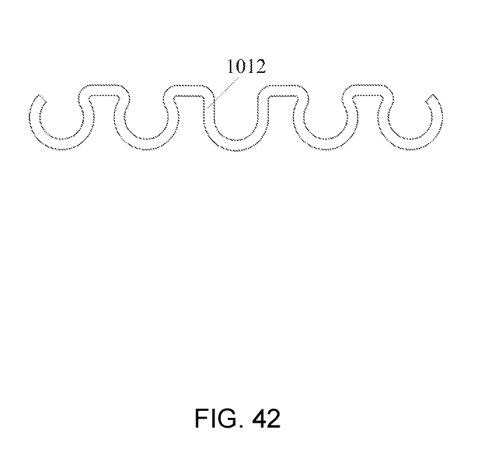

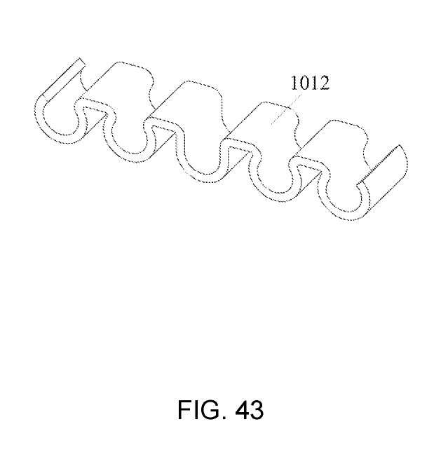

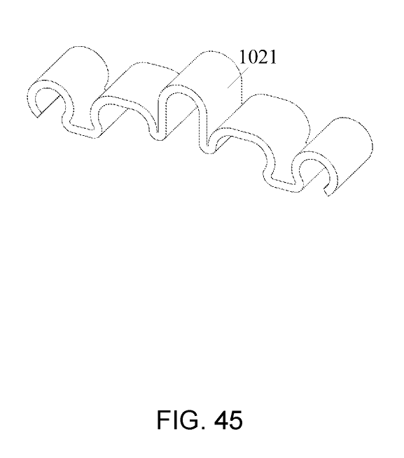

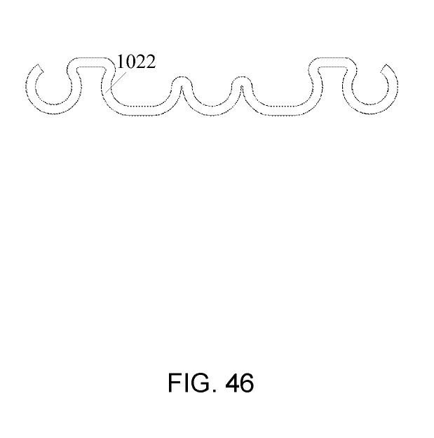

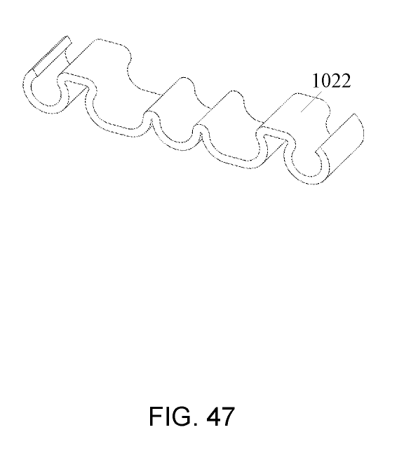

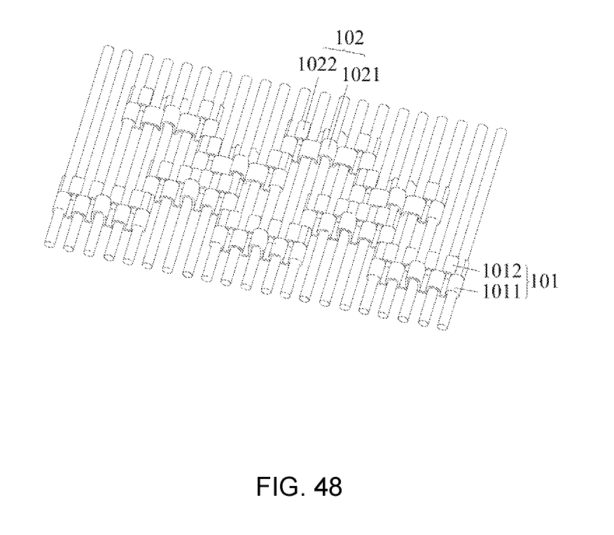

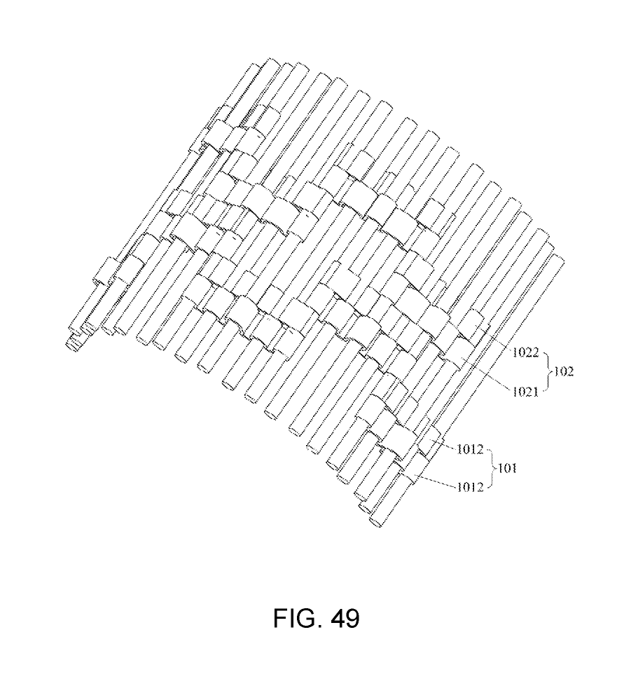

In the embodiments of the present application, in order to keep the device body in a deformed state after an external force is withdrawn (e.g., so as to maintain stability of the display screen after being folded), the electronic device further includes a flexible support apparatus. Reference is made to FIGS. 6 to 51, which are schematic views showing the structure of the flexible support apparatus and like reference numbers are used throughout the figures.

The flexible support apparatus includes a first sliding shaft 301, a second sliding shaft 302, a middle sliding shaft group, and a connecting member group. The middle sliding shaft group includes multiple middle sliding shafts 303 arranged in a row. Axes of the first sliding shaft 301, the second sliding shaft 302, and the middle sliding shafts 303 are parallel to each other, and the first sliding shaft 301 and the second sliding shaft 302 are located on two sides of the middle sliding shaft group. The middle sliding shaft group is movably connected to the first sliding shaft 301 and the second sliding shaft 302 by the connecting member group. The flexible support apparatus is bendable along an extending direction of the middle sliding shaft group, and a bent portion formed after bending the flexible support apparatus is always of an arc-shaped structure.

The flexible support apparatus according to the present application is embodied as a mechanical structure to realize the bending deformation, thus compared with a plastic plate in the prior art, can avoid issues of degraded bending performance and breakage caused after the plastic plate is frequently used.

In the above flexible support apparatus, the bent portion includes M sliding shafts and the bent portion being of the arc-shaped structure means that an external tangent surface of the M sliding shafts is an arc-shaped surface.

Further, in the above flexible support apparatus, in the case where the M sliding shafts form the arc-shaped structure, the sliding shafts on a first side of each of the M sliding shafts are stationary with respect to each other, and the sliding shafts on a second side of each of the M sliding shafts are stationary with respect to each other. In the flexible support apparatus, the sliding shafts on two sides of each of the M sliding shafts are respectively stationary in the process of the M sliding shafts forming the arc-shaped structure. Namely, portions on two sides of the bent portion of the flexible support apparatus are not deformed in the process of the M sliding shafts forming the arc-shaped structure. Therefore, it is convenient for users to bend the flexible support apparatus according to practical requirements. Of course, the M sliding shafts may be configured to include the first sliding shaft 301 and part of the middle sliding shaft group. Alternatively, the M sliding shafts may be configured to include the second sliding shaft 302 and part of the middle sliding shaft group. Alternatively, the M sliding shafts may be configured to include the first sliding shaft 301, the second sliding shaft 302 and the middle sliding shaft group. Correspondingly, the flexible support apparatus may form a C-type arc-shaped structure and may further be rolled into a scroll shape, which is convenient for the users to store.

Specifically, in the above flexible support apparatus, two ends of the connecting member group are respectively sleeved on the first sliding shaft 301 and the second sliding shaft 302 and a middle portion of the connecting member group is sleeved on the middle sliding shaft group.

The above connecting member group may be configured to include double shaft toothed blocks each being sleeved on the sliding shafts. The sliding shafts are connected as a whole by the double shaft toothed blocks and the double shaft toothed blocks that are adjacent are meshed to form an interference connection, thus allowing the M sliding shafts in the flexible support apparatus to form the arc-shaped structure. For simplifying the structure and facilitating the assembly, the above connecting structure is preferably configured to include a first connecting member 101 and a second connecting member 102.

The first connecting member 101 has five mounting holes distributed along the direction of a first straight line. Specifically, the mounting hole in the middle is a first mounting hole 111, and the mounting holes on two sides each are a second mounting hole 112. The first mounting hole 111 enables a sliding shaft in cooperation with the first mounting hole 111 to rotate about an axis of the sliding shaft and enables the sliding shaft to slide along a direction perpendicular to the direction of the first straight line. The second mounting hole 112 enables a sliding shaft in cooperation with the second mounting hole 112 to rotate about an axis of the sliding shaft.

The second connecting member 102 has five mounting holes distributed along the direction of a second straight line. Specifically, the mounting hole in the middle is a third mounting hole 121 and two mounting holes directly adjacent to the third mounting hole 121 are each a fourth mounting hole 122, and two mounting holes on two ends are each a fifth mounting hole 123. The third mounting hole 121 enables a sliding shaft in cooperation with the third mounting hole 121 to rotate about an axis of the sliding shaft and enables the sliding shaft to slide along a direction perpendicular to the direction of the second straight line. The fourth mounting hole 122 enables a sliding shaft in cooperation with the fourth mounting hole to rotate about an axis of the sliding shaft and enables the sliding shaft to slide along the direction of the second straight line. The fifth mounting hole 123 enables the sliding shaft in cooperation with the fifth mounting hole 123 to rotate about an axis of the sliding shaft.

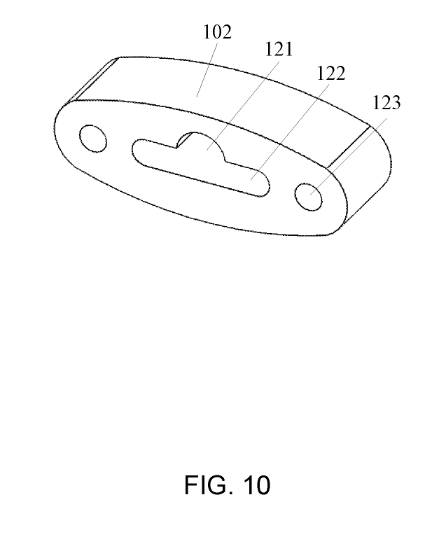

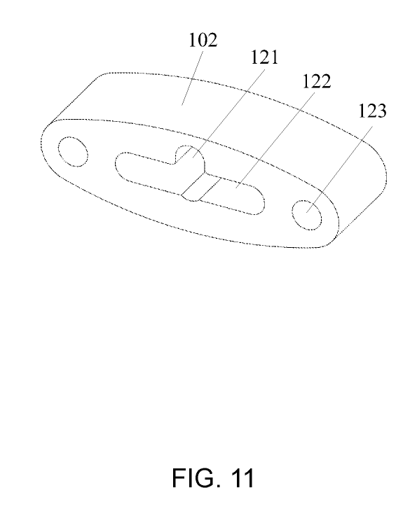

The first connecting members 101 are connected end-to-end in order along an arrangement direction of the middle sliding shaft group and form a first connecting member group. The second connecting members 102 are connected end-to-end in order along an arrangement direction of the middle sliding shaft group and form a second connecting member group. The first mounting hole 111 and the corresponding fifth mounting hole 123 are sleeved on the same sliding shaft. Being connected end-to-end as described above means that the mounting holes at ends of two adjacent connecting members are sleeved on the same sliding shaft. Therefore, the first connecting member group and the second connecting member group each having connecting members staggered are respectively formed. Of course, for facilitating manufacturing, the third mounting hole 121 and two fourth mounting holes 122 may be arranged to communicate with each other, as shown in FIGS. 10 and 11.

In the flexible support apparatus according to this embodiment, two kinds of connecting members are respectively sleeved on the sliding shafts, which allow the M sliding shafts to form the arc-shaped structure by movements of the sliding shafts in the mounting holes and slight deformations of the sliding shafts during the using process. Therefore, the structure thereof is simple and the assembly is facilitated. In practical use, by reasonably designing the size of each of the mounting holes, the external tangent surface of the above M sliding shafts is allowed to be deformed as a circular-arc-shaped surface. Therefore, in one aspect, the external tangent can meet use requirements of the users, and in another aspect, facilitating the reduction of the volume of the flexible support apparatus in the case where the flexible support apparatus is folded into an u-shaped structure or a snake-shaped structure, thereby providing convenience for the users in storing the flexible support apparatus.

In the flexible support apparatus according to the above embodiment, the number of the first connecting members 101 in the first connecting member group is at least five and the number of the second connecting members 102 in the second connecting member group is at least four. This ensures that the flexible support apparatus can be bent and the bent portion is always of an arc shape in the bending process.

The above flexible support apparatus may be configured to be bendable along only one side. Correspondingly, one edge of the first mounting hole 111 extends beyond one side of the first straight line and another edge of the first mounting hole 111 is leveled with an edge portion of the second mounting hole 112. Furthermore, one edge of the third mounting hole 121 extends beyond one side of the second straight line and another edge of the third mounting hole 121 is leveled with an edge portion of the fourth mounting hole 122 and an edge portion of the fifth mounting hole 123. Also, extending directions of the first mounting hole 111 and the third mounting hole 121 are toward the same side of the flexible support apparatus. The flexible support apparatus according to this embodiment can only be bent from a straight state toward one side of the flexible support apparatus and can thus prevent a device supported by the flexible support apparatus, such as a flexible screen, from being reversely bent and prevent the device such as the above flexible screen from being damaged.

Of course, the flexible support apparatus may further be configured to be bendable towards two sides according to practical requirements. Correspondingly, two edges of the first mounting hole 111 respectively extend beyond two sides of the first straight line and two edges of the third mounting hole 121 respectively extend beyond two sides of the second straight line. A bending direction of the flexible support apparatus is not limited in this embodiment and the bending direction may be set just by adjusting the extending directions of the first mounting hole 111 and the third mounting hole 121 according to practical requirements. In addition, a bending degree of the flexible support apparatus may be adjusted by adjusting lengths of the first mounting hole 111 and the third mounting hole 121 according to practical requirements.

Since an object supported by the flexible support apparatus (for example the flexible screen) is usually required to remain in a fixed state during use, the flexible support apparatus according to the above embodiment is preferably configured to be able to remain in any bent state.

Specifically, the above flexible support apparatus may be kept in any bent state through an additional member as provided, for example, the connecting member group is configured to further include a third connecting member 103 and a fourth connecting member 104. The third connecting members 103 have the same structure and arrangement way as the first connecting members 101 and each of the third connecting members 103 and the corresponding first connecting member 101 are sleeved on the same sliding shaft. The fourth connecting members 104 have the same structure and arrangement as the second connecting members 102 and each of the fourth connecting members 104 and the corresponding second connecting member 102 are sleeved on the same sliding shaft. The two second mounting holes 112 located on two ends of each of the third connecting members 103 can provide a rotation damping to the sliding shafts corresponding to the two second mounting holes 112 respectively. The fifth mounting holes 123 of each of the fourth connecting members 104 can provide a rotation damping to the sliding shafts corresponding to the fifth mounting holes 123 respectively. The two second mounting holes 112 located on two ends of each of the third connecting members 103 and the fifth mounting holes 123 of each of the fourth connecting members 104 can be respectively configured as a hole with an opening, which not only facilitates the assembly with the mounting holes, but also may allow the above two kinds of mounting holes to provide the rotation damping to the corresponding sliding shafts through an interference fit.

Of course, for reducing the number of the connecting members and simplifying assembly and operation, the flexible support apparatus according to the above embodiment may be further configured in such a way that the second mounting holes 112 located on two ends of the first connecting member and the fifth mounting holes 123 of the second connecting member are each configured as a mounting hole capable of providing a rotation damping to the corresponding sliding shaft, to enable the flexible support apparatus to remain in any bent state. Specifically, a friction pad for closely cooperating with the sliding shaft, such as a rubber pad, may be fixed in the mounting hole.

In the above flexible support apparatus, the connecting members in the connecting member group are all staggered. Therefore, there are many gaps, which are apt to cause damage to the device supported by the flexible support apparatus in the case where the device receives an external force. Therefore, the flexible support apparatus according to the above embodiment further includes a filling block 200. The filling block 200 being sleeved on the sliding shaft and is located between two connecting members spaced apart from each other in the connecting member group. Three sliding shafts are arranged between the two connecting members spaced apart from each other in the above connecting member group, and to avoid an interference in relative movements of the three sliding shafts, the above filling block 200 is only sleeved on one of the three sliding shafts. Of course, any two of the three sliding shafts may each be provided with the filling block 20, or the three sliding shafts may each be provided with the filling block 200.

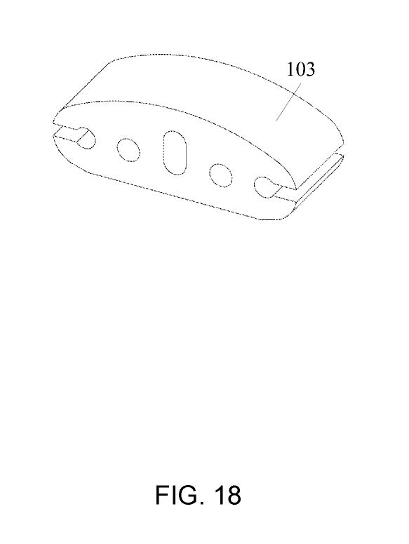

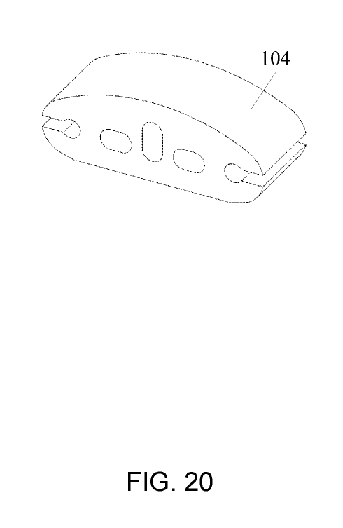

In an embodiment, one side of the flexible support apparatus according to the above embodiment is flat when the flexible support apparatus is unbent, which facilitates the arrangement of the flexible screen. The flexible support apparatus may adopt the first connecting member 101 in FIG. 6, the second connecting member 102 in FIG. 10, the third connecting member 103 in FIG. 18, and the fourth connecting member 104 in FIG. 20.

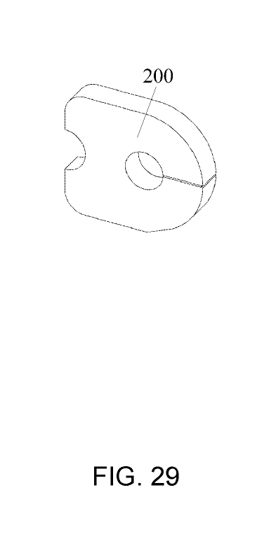

In the above flexible support apparatus, the first connecting member 101 and the second connecting member 102 may be respectively configured to have a block-like structure. Correspondingly, the third connecting member 103, the fourth connecting member 104, and the filling block 200 may have structures respectively shown in FIGS. 6 to 11. The first connecting member 101 and the second connecting member 102 may further be each configured to be of a sheet-like structure which can be conveniently manufactured by stamping. Correspondingly, the third connecting member 103, the fourth connecting member 104, and the filling block 200 are of the structures which can be conveniently manufactured by stamping as shown in FIGS. 29-31 respectively.

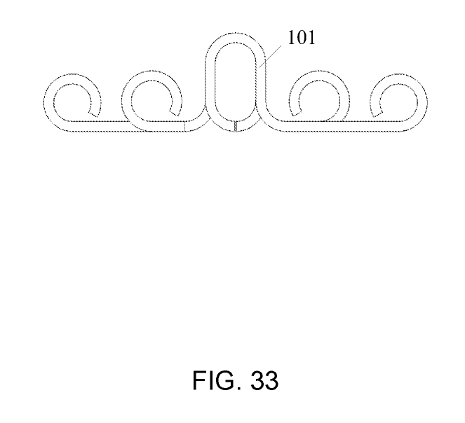

For reducing the size of the flexible support apparatus, the above first connecting member 101 and the second connecting member 102 may further be configured to be of the structures in FIGS. 33-36 respectively. The first connecting member 101 and the second connecting member 102 are respectively manufactured with a steel sheet by stamping, bending and curling, to allow the mounting holes to be encircled by curled edges and allow the curled edges of the second mounting holes 112 located on two ends of the first connecting member 101 and the fifth mounting holes 123 of the second connecting member 102 to tightly hold the sliding shafts to provide the rotation damping to the sliding shafts.

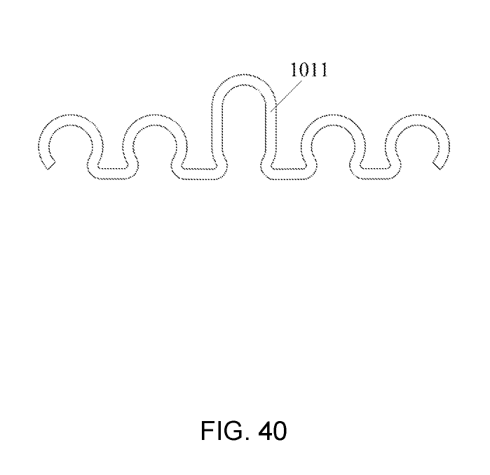

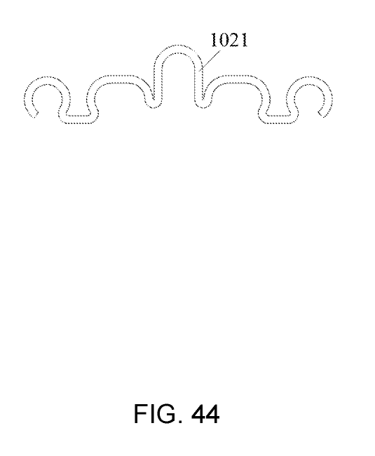

Further, for omitting the curling procedure, and for facilitating production and manufacturing, the first connecting member 101 in the above flexible support apparatus may be further configured to include a first member portion 1011 and a second member portion 1012. The two member portions are respectively sleeved on the same sliding shaft and form the first mounting hole 111 and the second mounting hole 112 together, as shown in FIGS. 40-43 and FIGS. 48-49. Correspondingly, the second connecting member 102 is configured to include a third member portion 1021 and a fourth member portion 1022. The two member portions are respectively sleeved on the same sliding shaft and form the third mounting hole 121, the fourth mounting hole 122 and the fifth mounting holes 123 together, as shown in FIGS. 44-49. In an embodiment, the flexible support apparatus according to this embodiment can be manufactured to have an overall thickness of only 1.2 millimeters.

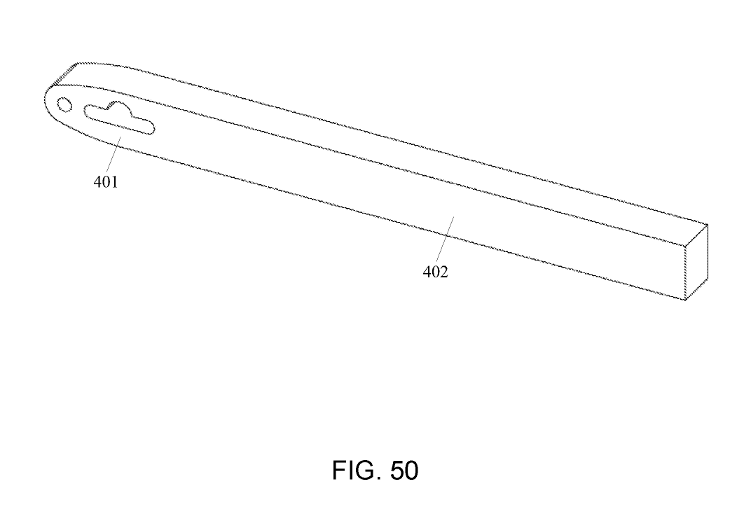

The above flexible support apparatus further includes a first fixed connection piece configured to be fixedly connected to a frame of the electronic device, as shown in FIG. 50. The first fixed connection piece includes a mounting handle 402 and a mounting portion 401 fixedly connected to the mounting handle. The mounting portion 401 is provided with mounting holes and is configured to be sleeved on the first sliding shaft 301 and the middle sliding shaft 303 adjacent to the first sliding shaft 301. Alternatively, the mounting portion is configured to be sleeved on the second sliding shaft 302 and the middle sliding shaft 303 adjacent to the second sliding shaft. According to the practical arrangement of the first connecting members 101 and the second connecting members 102 in the flexible support apparatus, the above mounting holes may be configured to be the same as the mounting holes in the first connecting member 101 or the same as the mounting holes in the second connecting member 102. Or the above mounting holes may also be configured to only include three mounting holes, the three mounting holes being respectively the same as the first mounting hole 111 and the two second mounting holes 112 located on the same side of the first mounting hole or the three mounting holes being respectively the same as the third mounting hole 121 and the fourth mounting hole 122 and the fifth mounting hole 123 located on the same side of the third mounting hole 121. The number and structure of the mounting holes in the mounting portion are not limited in this embodiment; however, it should be ensured that the flexible support apparatus can be normally deformed when the mounting portion is sleeved on the sliding shafts.

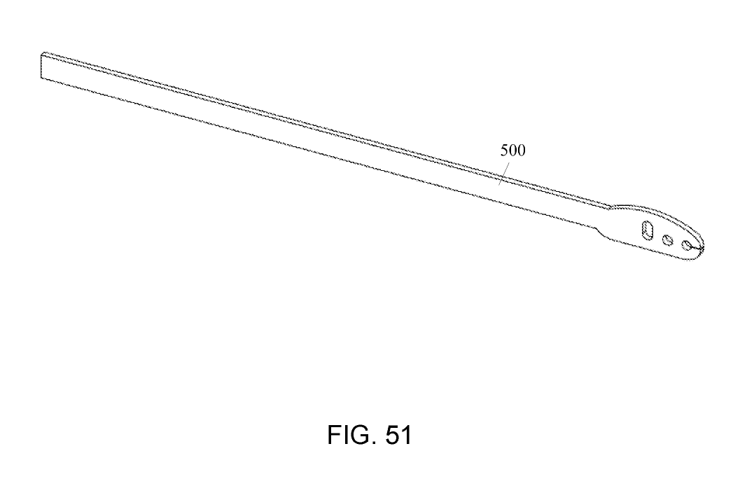

Further, the above flexible support apparatus further includes a second fixed connection piece 500, illustrated in FIG. 51. The second fixed connection piece having the same structure as the first fixed connection piece and a mounting hole at an end of a mounting portion of the second fixed connection piece is a hole with opening, which is configured to be in an interference fit with the sliding shaft corresponding to the mounting hole.

By means of one or more technical solutions in the embodiments of the present application, the following one or more technical effects can be achieved:

In the solutions of the embodiments of the present application, the electronic device includes a device body and a display screen arranged on the device body, the display screen including a first display region and a second display region. Specifically, the electronic device has a first display mode and a second display mode different from the first display mode. In the first display mode, the device body is in an unfolded state, the electronic device displays contents to be displayed on the first display region. In the second display mode, the device body of the electronic device is in a folded state and the electronic device displays the contents to be displayed on the second display region. As described, when the electronic device is in different folded modes, the display regions of the display screen are different, thus addressing the technical issue in the prior art that a flexible electronic device has a dull display effect, and achieving the technical effect of enriching the display effect of a flexible electronic device.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. An electronic device, comprising:
a flexible device body; and
at least one display screen arranged on the device body;
a processor;
a memory device that stores instructions executable by the processor to:
determine a display mode of the electronic device, wherein the display mode comprises a first display mode and a second display mode; and
display, based on the determining, contents on the at least one display screen;
wherein the electronic device in the first display mode is in an unfolded state and wherein the electronic device in the second display mode is in a folded state.

2. The electronic device of claim 1, wherein the at least one display screen comprises a single display screen, wherein the single display screen is a flexible display screen.

3. The electronic device of claim 2, wherein the instructions executable by the processor to display comprise instructions executable by the processor to display contents on at least one sub-display region of the single display screen based on determining the electronic device is in the second display mode.

4. The electronic device of claim 1, wherein the at least one display screen comprises a first display screen and a second display screen, wherein the first display screen is a flexible display screen arranged on a first side of the device body and wherein the second display screen is a non-flexible display screen arranged on a second side of the device body, wherein the second side is opposite from the first side.

5. The electronic device of claim 4, wherein the instructions executable by the processor to display comprise instructions executable by the processor to display contents on the first display screen based on determining the electronic device is in the first display mode.

6. The electronic device of claim 4, wherein the instructions executable by the processor to display comprise instructions executable by the processor to display contents on the second display screen based on determining the electronic device is in the second display mode.

7. The electronic device of claim 4, wherein the instructions are further executable by the processor to receive user input at an input device arranged on the second side in the second display mode.

8. The electronic device of claim 1, further comprising a flexible support apparatus capable of keeping the device body in the second display mode.

9. The electronic device of claim 9, wherein the flexible support apparatus comprises:
a first sliding shaft;
a second sliding shaft;
a middle sliding shaft group comprising a plurality of middle sliding shafts arranged in a row; and
a connecting member group, wherein the middle sliding shaft group is movably connected to the first sliding shaft and the second sliding shaft by the connecting member group;
wherein the flexible support apparatus is bendable along an extending direction of the middle sliding shaft group and forms a bent arc-shaped structure in the second display mode.

10. The electronic device of claim 9, wherein the bent arc-shaped structure comprises M sliding shafts.

11. The electronic device of claim 10, wherein the M sliding shafts comprise a first side and a second side, wherein the M sliding shafts on the first side and the second side are stationary.

12. A method, comprising:
determining, using a processor, a display mode of the electronic device, wherein the display mode comprises a first display mode and a second display mode; and
displaying, based on the determining, contents on the at least one display screen;
wherein the electronic device in the first display mode is in an unfolded state and wherein the electronic device in the second display mode is in a folded state.

13. The method of claim 12, wherein the at least one display screen comprises a single display screen, wherein the single display screen is a flexible display screen.

14. The method of claim 13, wherein the displaying comprises displaying contents on at least one sub-display region of the single display screen based on determining the electronic device is in the second display mode.

15. The method of claim 12, wherein the at least one display screen comprises a first display screen and a second display screen, wherein the first display screen is a flexible display screen arranged on a first side of the device body and wherein the second display screen is a non-flexible display screen arranged on a second side of the device body, wherein the second side is opposite from the first side.

16. The method of claim 15, wherein the displaying comprises displaying contents on the first display screen based on determining the electronic device is in the first display mode.

17. The method of claim 15, wherein the displaying comprises displaying contents on the second display screen based on determining the electronic device is in the second display mode.

18. The method of claim 15, further comprising receiving user input at an input device arranged on the second side of the device.

19. The method of claim 12, further comprising a flexible support apparatus, wherein the flexible support apparatus comprises:
a first sliding shaft;
a second sliding shaft;
a middle sliding shaft group comprising a plurality of middle sliding shafts arranged in a row; and
a connecting member group, wherein the middle sliding shaft group is movably connected to the first sliding shaft and the second sliding shaft by the connecting member group;
wherein the flexible support apparatus is bendable along an extending direction of the middle sliding shaft group and forms a bent arc-shaped structure in the second display mode.

20. A product, comprising:
a flexible device body;
at least one display screen arranged on the device body;
a storage device that stores code, the code being executable by the processor and comprising:
code that determines a display mode of an electronic device, wherein the display mode comprises a first display mode and a second display mode; and
code that displays, based on the determining, contents on the at least one display screen;
wherein the electronic device in the first display mode is in an unfolded state and wherein the electronic device in the second display mode is in a folded state.
